(19) United States
(12) Patent Application Publication
(10) Pub. No.: US 2005/0185518 A1
(43) Pub. Date: Aug. 25, 2005

(54) Decorative article, method of manufacturing same, and timepiece

(75) Inventors: Atsushi Kawakami, Matsumoto-shi (JP); Yoshiyuki Obi, Chino-Shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjyuku-ku (JP)

(21) Appl. No.: 11/048,054

(22) Filed: Feb. 2, 2005

(30) Foreign Application Priority Data
Feb. 2, 2004 (JP) 2004-026130

(51) Int. Cl. B29D 9/00; B29C 45/00

(52) U.S. Cl. 368/232

(57) ABSTRACT

An ornamental article 1 has: a plastic material substrate 2; a first film 3 on the substrate 2 and made of a made of a material containing at least one substance selected from the group made of Cr, Ti, compounds of Cr, and compounds of Ti; and a second film provided adjacent to the surface of the first film that is on the opposite side of the side that faces the substrate and made of a material containing at least one metal selected from the group made of Ag and Al. It is preferred that the first film 3 contain at least one substance selected from the group made of Cr, Ti oxide, and Cr oxide. It is also preferred that the sum of the average thicknesses of the first film 3 and second film 4 be from 0.02 to 2.5 micrometers.

### BACKGROUND OF THE INVENTION

1. Field of the Invention

The present invention generally relates to a decorative article. More specifically, the present invention relates to a decorative article, a method of manufacturing a decorative article, and a timepiece.

2. Background Information

Decorative articles, such as external parts for timepieces, need to have a refined and beautiful appearance to make them attractive to users. Conventionally, this requirement has been met by making decorative articles out of such silver-colored metal materials as Pd, Rd, and Pt. However, these metal materials are expensive and cause the manufacturing cost of the decorative articles to be high. Ag and Al are also used as silver-colored substitutes for the aforementioned metal materials.

Meanwhile, there have been attempts, as shown, Japanese Laid-open Patent Publication No. 2003-239083 (page 4, left column, lines 37 to 42) to reduce manufacturing costs and to increase the degree of freedom with which decorative articles can be formed by using a plastic material as a substrate and forming a film made of a metal material on the surface of the substrate. Japanese Laid-open Patent Publication No. 2003-239083 is hereby incorporated by reference.

However, plastic generally has poor adhesion with respect to metal materials, particularly Al and Ag. Consequently, such plastic decorative articles suffer from such problems as easy peeling of the film from the substrate and poor durability of the decorative article.

In view of the above, it will be apparent to those skilled in the art from this disclosure that there exists a need for an improved decorative article, method of manufacturing the decorative article, and a timepiece. This invention addresses this need in the art as well as other needs, which will become apparent to those skilled in the art from this disclosure.

### SUMMARY OF THE INVENTION

An object of the present invention is to provide a ornamental article provided with a substrate made chiefly of a plastic material and having an excellent aesthetic appearance and excellent durability, a manufacturing method with which the decorative article can be made, and a timepiece equipped with the decorative article. The object is attained using the present invention as described below.

In accordance with a first aspect of the present invention, a decorative article is provided. The decorative article has a substrate, a first film, and a second film. The substrate is made chiefly of a plastic material. The first film is provided adjacent to the substrate. The first film is made of a material containing at least one substance selected from the group made of Cr, Ti, compounds of Cr, and compounds of Ti. The second film is provided adjacent to a surface of the first film that is on a side opposite a surface of the first film that faces the substrate. The second film is made of a material containing at least one metal selected from the group made of Ag and Al.

As a result, the present invention can offer a decorative article that has a substrate made chiefly of a plastic material and also has an excellent aesthetic appearance and excellent durability.

A decorative article according to a second aspect of the present invention is the article of the first aspect, wherein it is preferred for the substrate to be made of a material containing at least one substance selected from the group made of polycarbonate and acrylonitrile-butadiene-styrene copolymer (ABS resin). By using such a substrate, the decorative article as a whole can be provided with particularly excellent strength. Further, the degree of freedom with respect to forming during the manufacture of the decorative article is increased. In other words, the decorative article can be formed more easily.

A decorative article according to a third aspect of the present invention is the article of the first or second aspect, wherein it is preferred for the aforementioned compound to be a metal oxide. By using a metal oxide, excellent adhesion can be obtained between the substrate and the film.

A decorative article according to a fourth aspect of the present invention is the article of any one of the first to third aspects, wherein it is preferred that the first film be a laminate having a plurality of layers. By using a plurality of layers, particularly excellent adhesion can be obtained between the substrate and the second film. Additionally, the materials used for the substrate and the second film can be selected from a wider range of choices, enabling a decorative article having particularly excellent aesthetic beauty (aesthetic appearance) and durability to be obtained. Furthermore, since the selection of materials that can be used for the substrate is widened, the present invention can be applied in a favorable manner to, for example, more complexly shaped decorative articles.

A decorative article according to a fifth aspect of the present invention is the article of any one of the first to fourth aspects, wherein it is preferred that the first film have a first layer made chiefly of Cr and a second layer made chiefly of CrO. Further, the first layer is provided adjacent to the substrate and the second layer is provided adjacent to the surface of the first layer that is on the opposite side of the first layer as the surface of the first layer that faces the substrate. By using a first coat having these first and second layers, even better adhesion can be obtained between the first film and the substrate and between the first film and the second film. Additionally, the materials used for the substrate and the second film can be selected from an even wider range of choices, enabling the aesthetic beauty (aesthetic appearance) and durability of the decorative article to be raised to an even higher level. Furthermore, since the selection of materials that can be used for the substrate is widened, the present invention can be applied in an even more favorable manner to, for example, more complexly shaped decorative articles.

A decorative article according to a sixth aspect of the present invention is the article of any one of the first to fifth aspects, wherein it is preferred that the thickness of the first film be from 0.01 to 1.0 micrometer. By using a thickness in this range, the internal stresses of the first film can be sufficiently prevented from becoming too high and particularly excellent adhesion can be obtained between the substrate and the second film.

A decorative article according to a seventh aspect of the present invention is the article of any one of the first to sixth aspects, wherein it is preferred that the thickness of the second film be from 0.01 to 1.5 micrometers. By using a thickness in this range, the internal stresses of the second film can be sufficiently prevented from becoming too high and particularly excellent adhesion can be obtained between the first film and the second film.

A decorative article according to an eighth aspect of the present invention is the article of any one of the first to seventh aspects, wherein it is preferred that the sum of the thickness of the first film and the thickness of the second film be from 0.02 to 2.5 micrometers. By configuring the films such that the sum of the thicknesses is in this range, the internal stresses of the first and second films can be sufficiently prevented from becoming too high and particularly excellent adhesion can be obtained between the substrate, the first film, and the second film. Additionally, when the sum of the average thickness of the first film and the average thickness of the second film is a value in the range described above, the radio wave permeability of the decorative article as a whole is improved. As a result, the decorative article can be used more favorably as a part for a radio controlled timepiece.

A decorative article according to a ninth aspect of the present invention is the article of any one of the first to eighth aspects, wherein it is preferred that a topcoat layer made chiefly of a resin material be provided over the second film. By providing such a topcoat, the aesthetic appearance of the decorative article, for example, can be improved even further. Furthermore, degradation and denaturation of the second film due to the effects of the external environment can be prevented more reliably and the decorative article can be provided with particularly excellent durability.

A decorative article according to a tenth aspect of the present invention is the article of any one of the first to ninth aspects, wherein it is preferred that the topcoat layer be made chiefly of a urethane resin and/or an acrylic resin. By making the topcoat out of such a resin, a topcoat having particularly excellent adhesion can be achieved.

A decorative article according to an eleventh aspect of the present invention is the article of any one of the first to tenth aspects, wherein the article is an external part for a timepiece. The external parts of timepieces are generally vulnerable to physical impact from the outside and need to be durable in order to be practical. At the same time, they need to possess a beautiful appearance. The present invention can satisfy these requirements simultaneously.

A decorative article according to a twelfth aspect of the present invention is the article of any one of the first to eleventh aspects, wherein the article is a part for a radio controlled timepiece. In addition to having an excellent aesthetic appearance and excellent durability, a decorative article according to the present invention has excellent radio wave permeability because the substrate is made of a plastic material. Therefore, a decorative article according to the present invention can be used in a favorable manner as a part for a radio controlled timepiece.

A decorative article manufacturing method according to a thirteenth aspect of the present invention is a manufacturing method for the decorative article described heretofore. Specifically, the method includes:
a first step in which a first film made of a material containing at least one substance selected from the group made of Cr, Ti, compounds of Cr, and compounds of Ti is formed on at least a portion of a surface of a substrate made chiefly of a plastic material; and
a second step in which a second film made of a material containing at least one metal selected from the group made of Ag and Al is formed on at least a portion of the surface of the first film.

As a result, the present invention can offer a decorative article manufacturing method wherewith it is possible to manufacture a decorative article that is provided with a substrate made chiefly of a plastic material and also has an excellent aesthetic appearance and excellent durability.

A decorative article manufacturing method according to a fourteenth aspect of the present invention is the method of the thirteenth aspect, wherein it is preferred that the first step be executed using a vapor phase film forming method. By using a vapor phase film forming method, a first film having a uniform thickness and excellent adhesion to the substrate can be formed in a reliable fashion. As a result, a decorative article having a particularly excellent aesthetic appearance and particularly excellent durability can be obtained. Additionally, since the variation of the thickness of the first film can be made quite small even if the first film is comparatively thin, this manufacturing method is also advantageous from the standpoint of improving the radio wave permeability of the decorative article.

A decorative article manufacturing method according to a fifteenth aspect of the present invention is the method of the fourteenth aspect, wherein it is preferred that the first step be executed using sputtering. By using sputtering, a first film having a uniform thickness and excellent adhesion to the substrate can be formed in an even more reliable fashion. As a result, a decorative article having a particularly excellent aesthetic appearance and particularly excellent durability can be obtained. Additionally, since the variation of the thickness of the first film can be made quite small even if the first film is comparatively thin, this manufacturing method is also advantageous from the standpoint of improving the radio wave permeability of the decorative article.

A decorative article manufacturing method according to a sixteenth aspect of the present invention is the method of any one of the thirteenth to fifteenth aspects, wherein it is preferred that the second step be executed using a vapor phase film forming method. By using a vapor phase film forming method, a second film having a uniform thickness and excellent adhesion to the first film can be formed in a reliable fashion. As a result, a decorative article having a particularly excellent aesthetic appearance and particularly excellent durability can be obtained. Additionally, since the variation of the thickness of the second film can be made quite small even if the second film is comparatively thin. This aspect of the manufacturing method is also advantageous from the standpoint of improving the radio wave permeability of the decorative article.

A decorative article manufacturing method according to a seventeenth aspect of the present invention is the method of the sixteenth aspect, wherein it is preferred that the second step be executed using sputtering.

By using a vapor phase film forming method, a second film having a uniform thickness and excellent adhesion to the first film can be formed in an even more reliable fashion. As a result, a decorative article having a particularly excellent aesthetic appearance and particularly excellent durability can be obtained. Additionally, since the variation of the thickness of the second film can be made quite small even if the second film is comparatively thin, this manufacturing method is also advantageous from the standpoint of improving the radio wave permeability of the decorative article.

A decorative article manufacturing method according to an eighteenth aspect of the present invention is the method of any one of the thirteenth to seventeenth aspects, wherein the method preferably further includes a third step, executed after the second step, in which a topcoat layer having chiefly a resin material is formed. By providing such a topcoat, the aesthetic appearance of the decorative article, for example, can be improved even further. Furthermore, degradation and denaturation of the second film due to the effects of the external environment can be prevented more reliably and the decorative article can be provided with particularly excellent durability.

A timepiece in accordance with a nineteenth aspect of the present invention is equipped with a decorative article in accordance with any one of the first to twelfth aspects of the present invention. As a result, a timepiece having an excellent aesthetic appearance and excellent durability can be provided.

The present invention makes it possible to offer a decorative article provided with a substrate made chiefly of a plastic material and having an excellent aesthetic appearance and excellent durability, a manufacturing method with which the decorative article can be made, and a timepiece equipped with the decorative article.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross sectional view showing a preferred embodiment of a decorative article in accordance with a first preferred embodiment of the present invention.

FIG. 2 is a view of a series of cross sectional views illustrating a preferred embodiment of manufacturing method for the decorative article in accordance with the present invention;

FIG. 3 is a partial cross sectional view showing a preferred embodiment of timepiece (portable timepiece) having the decorative article in accordance with the present invention;

FIG. 4 is a view of a table showing results of using the manufacturing method for the decorative article of the present invention;

FIG. 5 is a view of a table further showing results of using the manufacturing method for the decorative article of the present invention;

FIG. 6 is a perspective view showing a timepiece having the decorative article of the present invention; and

FIG. 7 is a cross-sectional view of a part of the timepiece.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Preferred embodiments of a decorative article, a decorative article manufacturing method, and a timepiece in accordance with the present invention will now be described with reference to the appended drawings.

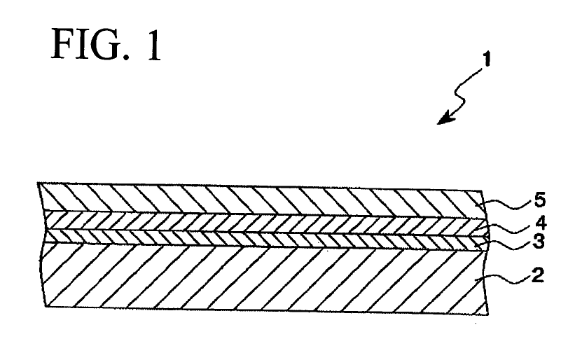

First, a preferred embodiment of a decorative article 1 in accordance with a preferred embodiment of the present invention will be described. FIG. 1 is a cross sectional view showing the preferred embodiment of the decorative article 1 in accordance with the present invention. As shown in FIG. 1, the decorative article 1 of this embodiment has a substrate 2, a first film 3, a second film 4 made of a material containing at least one metal selected from the group made of Ag and Al, and a topcoat layer 5.

Substrate

The substrate 2 is made chiefly of a plastic material. Plastic materials from which the substrate 2 can be made include any of various thermoplastic resins and thermosetting resins. For example, the substrate can be made of any one of the following materials or a combination of two or more of the following materials (e.g., a blend resin, polymer alloy, or laminate made with two or more of the following materials): polyolefins such as polyethylenes, polypropylenes, ethylene-propylene copolymers, and ethylene-vinyl acetate copolymers (EVA); cyclic polyolefins; modified polyolefins; polyvinyl chlorides; polyvinylidene chlorides; polystyrenes; polyamides (e.g., nylon 6, nylon 46, nylon 66, nylon 610, nylon 612, nylon 11, nylon 12, nylon 6-12, nylon 6-66); polyimides; polyamide-imides; polycarbonates (PC); poly-(4-methylpentene-1), ionomers; acrylic resins; polymethyl methacrylates; acrylonitrile-butadiene-styrene copolymers (ABS resins); acrylonitrile-styrene copolymers (AS resins); butadiene-styrene copolymers; polyoxymethylenes; polyvinyl alcohols (PVA); ethylene-vinyl alcohol copolymer (EVOH); polyesters such as polyethylene terephthalates (PET), polybutylene terephthalates (PBT), and polycyclohexane terephthalates (PCT); polyethers; polyether ketones (PEK); polyether ether ketones (PEEK); polyether imides; polyacetals (POM); polyphenylene oxides; modified polyphenylene oxides; polysulfones; polyethersulfones, polyphenylene sulfides; polyarylates; aromatic polyesters (liquid crystal polymers); polytetrafluoroethylenes, polyvinylidene fluorides, and other fluororesins; various thermoplastic elastomers based on a styrene, polyolefin, polyvinyl chloride, polyurethane, polyester, polyamide, polybutadiene, trans polyisoprene, fluororubber, or polyethylene chloride; epoxy resins, phenolic resins; urea resins; melamine resins; unsaturated polyesters; silicone resins; urethane resins; and poly-paraxylylene resins such as polyparaxylylene, poly-monochloro-paraxylylene, poly-dichloro-paraxylylene, poly-monofluoro-paraxylylene, and poly-monoethyl-paraxylylene.

Among the materials mentioned above, it is preferred for the substrate 2 to be made of a material containing at least one of the following: a polycarbonate or an acrylonitrile-butadiene-styrene copolymer (ABS resin). By making the substrate 2 of such a material, the decorative article 1 as a whole can be provided with particularly excellent strength. Additionally, since the degree of freedom with respect to forming during the manufacture of the decorative article 1 is increased (since the decorative article can be formed more easily), the decorative article can be manufactured easily and reliably even if it has a complex shape. Since polycarbonates are comparatively inexpensive among plastic materials, the use of a polycarbonate can contribute to further reductions in the production cost of the decorative article 1. Meanwhile, since ABS resins have particularly excellent chemical resistance, the use of an ABS resin can further improve the durability of the decorative article 1 as a whole. Although polycarbonates (PC) ad acrylonitrile-butadiene-styrene copolymers (ABS resins) have the excellent qualities mentioned above, they demonstrate particularly poor adhesion with respect to Ag and Al, which are used for the second film 4 as discussed in detail later. Therefore, the effects of the present invention become particularly prominent when the substrate is made of a material containing at least one substance selected from the group made of polycarbonates and acrylonitrile-butadiene-styrene copolymers (ABS resins). In short, the decorative article as a whole can be imparted with excellent aesthetic beauty (aesthetic appearance) and durability while also amply exhibiting the distinctive features of polycarbonates and acrylonitrile-butadiene-styrene copolymers (ABS resins).

It is also acceptable for the substrate 2 to contain non-plastic components. Examples of such components include plasticizers, antioxidants, coloring agents (e.g., color formers, fluorescent substances, phosphorescent substances), brightening agents (i.e., gloss improvers), and fillers. It is acceptable for the substrate 2 to have parts thereof that are made of materials that do not contain a plastic material so long as at least a portion of the substrate 2 near the surface thereof (i.e., the part where the first film 3 (discussed later) will be formed) is made chiefly of a plastic material. Also, it is acceptable for the substrate 2 to be made either such that the composition of the material is substantially uniform in all regions of the substrate 2 or such that the composition varies depending on the region. For example, the substrate 2 can be configured to have a base part and a surface layer provided over the base part. In the case of a substrate 2 configured in this manner, at least a portion of the substrate 2 near the surface thereof (i.e., the part where the first film 3 (discussed later) will be formed) should be made chiefly of a plastic material.

The shape and size of the substrate 2 are not limited in any particular way and are normally determined based on the shape and size of the decorative article 1.

The substrate 2 can be formed by any method. Examples of the forming method for the substrate 2 include compression molding, extrusion, injection molding, and stereolithography.

First Film

As described previously, the decorative article 1 has a second film 4 made of a material containing at least one metal selected from the group made of Ag and Al and the decorative article 1 has an excellent aesthetic appearance (aesthetic beauty) as a result of having such a second film. The idea of a decorative article having a plastic substrate provided with a coating film made of a metal material has been in existence for some time. However, among metal materials, Ag and Al have particularly poor affinity with respect to plastic materials and have extremely poor adhesion with respect to plastic materials. Thus, it is difficult to form a film made of Ag or Al directly onto the surface of a substrate made of a plastic material and, even if one succeeds in forming such a film, the film will easily separate and peel off the substrate and the decorative article will have markedly inferior durability.

As a result of diligent research oriented toward resolving this problem, the inventors discovered that by providing a film (first film) made of a material containing at least one substance selected from the group made of Cr, Ti, compounds of Cr, and compounds of Ti between a substrate made chiefly of a plastic material and a film (second film) made of a material containing at least one metal selected from the group made of Ag and Al, a decorative article having an excellent aesthetic appearance (aesthetic beauty) and markedly improved durability due to improved adhesion between the substrate and the film (second film) can be realized. Therefore, in this embodiment, a first film 3 is also provided on the surface of the substrate 2.

The first film is made of a material (including alloys) containing at least one substance selected from the group made of Cr, Ti, compounds of Cr, and compounds of Ti. Examples of the compounds mentioned here include oxides, nitrides, carbides, and intermetallic compounds containing Cr and/or Ti. Among materials meeting the above requirements, it is particularly preferable that the material used to make the first film 3 be metallic Cr (or an alloy thereof) or an oxide of Cr or Ti (e.g., chromium oxide, titanium oxide, a complex oxide of chromium, or a complex oxide of titanium). By making the first film 3 out of such a material, excellent adhesion can be obtained between the substrate 2 and the second film 4. Although it is acceptable for the first film 3 to contain components other than Cr, Ti, compounds of Cr, or compounds of Ti (hereinafter referred to collectively as “Cr and Ti based substances”), it is preferred that the first film 3 be made chiefly of Cr and Ti based substances. More specifically, it is preferred that the first film 3 have a content (weight percent) of Cr and Ti based substances (total sum in the case of a plurality of Cr and Ti based substances) of 95 wt % or greater. A weight percent of 98 wt % or greater is even more preferable and a weight percent of 99 wt % or greater is more preferable still. The previously described effects are even more prominent when the content of Cr and Ti based substances is in the preferred range.

While there are no particular limitations on the average thickness of the first film 3, it is preferred that the average thickness of the first film 3 be 0.01 to 1.0 micrometer. An average thickness of 0.01 to 0.5 micrometer is even more preferable and an average thickness of 0.01 to 0.3 micrometer is more preferable still. When the average thickness of the first film 3 is in the aforementioned range, the internal stress of the first film 3 can be sufficiently prevented from becoming too high and particularly excellent adhesion can be obtained between the substrate 2 and the second film 4. Conversely, if the average thickness of the first film 3 is below the lower limit value of the aforementioned range, depending on the materials with which the first film 3, substrate 2, and second film 4 are made, it can be difficult to improve sufficiently the adhesion between the substrate 2 and the second film 4. Additionally, if the average thickness of the first film 3 is below the lower limit value of the aforementioned range, depending on the method used to form the first film 3, it is easy for pinholes to develop in the first film 3 and there is the possibility that the desired effect of providing the first film 3 will not be sufficiently realized. Meanwhile, if the average thickness of the first film 3 exceeds the upper limit value of the aforementioned range, the thickness of the first film 3 will tend to vary to a large degree from location to location. When the average thickness of the first film 3 is particularly large, the internal stress of the first film 3 becomes high and it is easy for cracking to occur.

It is acceptable for the first film 3 to be made either such that the composition of the material is uniform in all regions of the first film 3 or such that the composition is not uniform. For example, the first film 3 can be made of a gradient material, i.e., configured such that the components (composition) thereof change successively in the thickness direction. It is also acceptable for the first film 3 to be a laminate having a plurality of layers. The use of a laminate can further improve the adhesion of the first film 3 with respect to the substrate 2 and the second film 4. More specifically, the adhesion between the substrate 2 and the second film 4 can be improved further by configuring the laminate first film 3 such that the layer thereof that contacts the substrate 2 is made of a material having excellent adhesion with respect to the substrate 2 and the layer thereof that contacts the second film 4 is made of a material having excellent adhesion with respect to the second film 4. Additionally, by adopting a laminate first film 3, the materials used for the substrate 2 and the second film 4 can be selected from a wider range of choices, enabling the aesthetic beauty (external beauty) and durability of the decorative article 1 to be raised to a particularly excellent level. Furthermore, since the selection of materials that can be used for the substrate is widened, the present invention can be applied in a favorable manner to more complexly shaped decorative articles.

When the first film 3 is a laminate, it is preferred that the laminate have at least one layer that is made chiefly of a metal oxide. Also, when the first film 3 is a laminate, it is preferred that the first film 3 have a first layer made chiefly of Cr provided adjacent to the substrate 2 and a second layer made chiefly of CrO provided adjacent to the surface of the first layer that is on the opposite side of the first layer as the surface of the first layer that faces the substrate 2. In other words, it is preferred that the substrate 2, the first layer, and the second layer adjoin each other in the order listed. By using a first film 3 having these first and second layers, even better adhesion can be obtained between the substrate 2 and the second film 4. Additionally, the materials used for the substrate 2 and the second film 4 can be selected from an even wider range of choices, enabling the aesthetic beauty (external beauty) and durability of the decorative article 1 to be raised to an even higher level. Furthermore, since the selection of materials that can be used for the substrate 2 is widened, the present invention can be applied in an even more favorable manner to complexly shaped decorative articles 1.

When the first film 3 is a laminate, it is also acceptable to have a layer made, for example, of a material that essentially does not contain any Cr or Ti based substances. More specifically, it is acceptable for the first film 3 to have a layer made of a plastic material arranged between two layers made of Cr and Ti based substances.

Second Film

The second film 4 is provided on the outside surface of first film 3 (i.e., on the surface of the first film 3 that is on the opposite side of the first film 3 as the surface that contacts the substrate 2). As described previously, the second film 4 is made of a material (including alloys) containing at least one metal selected from the group made of Ag and Al. Such a second film 4 provides the decorative article 1 with an excellent aesthetic appearance. Although it is acceptable for the second film 4 to contain components other than Ag and Al, it is preferred that the second film 4 be made chiefly of Ag and/or Al. More specifically, it is preferred that the second film 4 have a total content (weight percent) of Ag and Al of 95 wt % or greater. A weight percent of 98 wt % or greater is even more preferable and a weight percent of 99 wt % or greater is more preferable still. The previously described effects are even more prominent when the content of Ag and/or Al is in the preferred range.

While there are no particular limitations on the average thickness of the second film 4, it is preferred that the average thickness of the second film 4 be 0.01 to 1.5 micrometers. An average thickness of 0.01 to 0.9 micrometer is even more preferable and an average thickness of 0.01 to 0.5 micrometer is more preferable still. When the average thickness of the second film 4 is in the aforementioned range, the internal stress of the second film 4 can be sufficiently prevented from becoming too high and excellent aesthetic beauty can be obtained for the decorative article 1. Furthermore, particularly excellent adhesion can be obtained between the first film 3 and the second film 4. Conversely, if the average thickness of the second film 4 is below the lower limit value of the aforementioned range, depending on the material from which the second film 4 is made, it can be difficult to obtain the luster and tint that the second film 4 is intended to provide and, thus, it can be difficult to improve sufficiently the aesthetic beauty of the decorative article 1 as a whole. Additionally, if the average thickness of the second film 4 is below the lower limit value of the aforementioned range, pinholes may occur easily in the second film 4 depending on the method used to form the second film 4. Furthermore, depending on the materials with which the first film 3 and second film 4 are made, it can be difficult to realize a sufficient improvement in adhesion between the first film 3 and the second film 4. Meanwhile, if the average thickness of the second film 4 exceeds the upper limit value of the aforementioned range, the thickness of the second film 4 will tend to vary to a large degree from location to location. When the average thickness of the second film 4 is particularly large, the internal stress of the second film 4 becomes high and it is easy for cracking to occur.

It is acceptable for the second film 4 to be made either such that the composition of the material is uniform in all regions of the second film 4 or such that the composition is not uniform. For example, the second film 4 can be made of a gradient material, i.e., configured such that the components (composition) thereof change successively in the thickness direction. It is also acceptable for the second film 4 to be a laminate having a plurality of layers. By using a laminate second film 4, excellent adhesion with respect to the first film 3 can be obtained while also further improving the aesthetic beauty of the decorative article 1. More specifically, by configuring the laminate such that the layer thereof that contacts the first film 3 is made of a material having excellent adhesion with respect to the first film 3 and the outermost layer thereof (i.e., the layer thereof that is farthest from the first film 3) is made of a material having excellent aesthetic beauty, excellent adhesion with respect to the first film 3 can be obtained while also further improving the aesthetic beauty of the decorative article 1. When the second film 4 is a laminate, it is also acceptable to have a layer made, for example, of a material that essentially does not contain any Ag or Al. More specifically, the second film 4 can be configured to have two layers made of a material containing Ag and/or Al and an intermediate layer made of a metal other than Ag and Al or a metal oxide or other metallic compound arranged there-between.

It is preferred that the sum of the average thickness of the first film 3 and the average thickness of the second film 4 be from 0.02 to 2.5 micrometers. An average thickness of 0.02 to 1.5 micrometers is even more preferable and an average thickness of 0.02 to 0.8 micrometer is more preferable still. When the sum of the average thickness of the first film 3 and the average thickness of the second film 4 is in the aforementioned range, the internal stresses of the first film 3 and second film 4 can be sufficiently prevented from becoming too high and particularly excellent adhesion can be obtained between the substrate 2, the first film 3, and the second film 4. Additionally, when the sum of the average thickness of the first film 3 and the average thickness of the second film 4 is a value in the aforementioned range, the radio wave permeability of the decorative article 1 as a whole is improved. As a result, the decorative article 1 can be used more favorably as a part for a radio controlled timepiece.

Topcoat Layer

The topcoat layer 5 is provided on the outside surface of the second film 4 (i.e., on the surface of the second film 4 that is on the opposite side of the second film 4 relative to the surface that contacts the first film 3). By providing such a topcoat layer 5, the luster and tint, for example, can be adjusted and the aesthetic appearance of the decorative article 1 can be improved even further. Additionally, by providing such a topcoat layer 5, the corrosion resistance, weather resistance, water resistance, oil resistance, scratch resistance, wear resistance, tarnish resistance, and other characteristics of the decorative article 1 as a whole can be improved and degradation and denaturation of the second film 4 due to the effects of the external environment can be prevented more reliably. As a result, a decorative article 1 having particularly excellent durability can be obtained.

Although the topcoat layer 5 can be made of any material, it is preferred that it be made of a material having an appropriate degree of transparency. Examples of materials meeting this criterion include various plastic materials (resin materials), various glasses, and diamond-like carbon (DLC). Among these materials, plastics are particularly preferred because they possess both excellent transparency and excellent formability (i.e., they are easy to process into the desired form).

Plastic materials (resin materials) from which the topcoat layer 5 can be made include any of various thermoplastic resins and thermosetting resins. For example, the topcoat layer can be made of any one of the following materials or a combination of two or more of the following materials (e.g., a blend resin, polymer alloy, or laminate made with two or more of the following materials): polyolefins such as polyethylenes, polypropylenes, ethylene-propylene copolymers, and ethylene-vinyl acetate copolymers (EVA); cyclic polyolefins; modified polyolefins; polyvinyl chlorides; polyvinylidene chlorides; polystyrenes; polyamides (e.g., nylon 6, nylon 46, nylon 66, nylon 610, nylon 612, nylon 11, nylon 12, nylon 6-12, nylon 6-66); polyimides; polyamide-imides; polycarbonates (PC); poly-(4-methylpentene-1), ionomers; acrylic resins; polymethyl methacrylates; acrylonitrile-butadiene-styrene copolymers (ABS resins); acrylonitrile-styrene copolymers (AS resins); butadiene-styrene copolymers; polyoxymethylenes; polyvinyl alcohols (PVA); ethylene-vinyl alcohol copolymer (EVOH); polyesters such as polyethylene terephthalates (PET), polybutylene terephthalates (PBT), and polycyclohexane terephthalates (PCT); polyethers; polyether ketones (PEK); polyether ether ketones (PEEK); polyether imides; polyacetals (POM); polyphenylene oxides; modified polyphenylene oxides; polysulfones; polyethersulfones, polyphenylene sulfides; polyarylates; aromatic polyesters (liquid crystal polymers); polytetrafluoroethylenes, polyvinylidene fluorides, and other fluororesins; various thermoplastic elastomers based on a styrene, polyolefin, polyvinyl chloride, polyurethane, polyester, polyamide, polybutadiene, trans polyisoprene, fluororubber, or polyethylene chloride; epoxy resins, phenolic resins; urea resins; melamine resins; unsaturated polyesters; silicone resins; urethane resins; and poly-paraxylylene resins such as polyparaxylylene, poly-monochloro-paraxylylene, poly-dichloro-paraxylylene, poly-monofluoro-paraxylylene, and poly-monoethyl-paraxylylene.

Among the materials listed above, it is particularly preferable for the topcoat layer 5 to be made of a material containing a urethane resin and/or an acrylic resin and more preferable still for the topcoat layer 5 to be made of a material made chiefly of a urethane resin and/or an acrylic resin. By using such a material, particularly excellent adhesion can be obtained between the topcoat layer 5 and the second film 4.

It acceptable for components other than these materials to be contained in the topcoat layer 5. Examples of such components include coloring agents (e.g., color formers, fluorescent substances, and phosphorescent substances), brightening agents (i.e., gloss improvers), plasticizers, antioxidants, and fillers.

While there are no particular limitations on the average thickness of the topcoat layer 5, it is preferred that the average thickness of the topcoat layer 5 be 0.01 to 50 micrometers. An average thickness of 0.1 to 20 micrometers is even more preferable and an average thickness of 2 to 15 micrometers is more preferable still. When the average thickness of the topcoat layer 5 is in the aforementioned range, the internal stress of the topcoat layer 5 can be sufficiently prevented from becoming too high and particularly excellent adhesion can be obtained between the topcoat layer 5 and the second film 4. Furthermore, a decorative article 1 having particularly excellent aesthetic beauty can be obtained. Conversely, if the average thickness of the topcoat layer 5 is below the lower limit value of the aforementioned range, depending on the materials of which the second film 4 and the topcoat layer 5 are made, it can be difficult to realize a sufficient improvement in the adhesion between the topcoat layer 5 and the second film 4. Furthermore, there is the possibility that the topcoat layer 5 will not sufficiently perform the functions it is intended to perform. Meanwhile, if the average thickness of the topcoat layer 5 exceeds the upper limit value of the aforementioned range, the thickness of the topcoat layer 5 will tend to vary to a large degree from location to location. When the average thickness of the topcoat layer 5 is particularly large, the internal stress of the topcoat layer becomes high and it is easy for cracking to occur. Furthermore, when the average thickness of topcoat layer 5 is particularly large, depending on the material (degree of transparency) with which the topcoat layer 5 is made and the material with which the second film 4 is made, it can be difficult to obtain the luster and tint that the second film 4 is intended to provide and, thus, it can be difficult to improve sufficiently the aesthetic beauty of the decorative article 1 as a whole.

It is acceptable for the topcoat layer 5 to be made either such that the composition of the material is uniform in all regions of the topcoat layer 5 or such that the composition is not uniform. For example, the topcoat layer 5 can be made of a gradient material, i.e., configured such that the components (composition) thereof change successively in the thickness direction. It is also acceptable for the topcoat layer 5 to be a laminate having a plurality of layers. By using a laminate topcoat layer 5, excellent adhesion with respect to the second film 4 can be obtained while also improving the aesthetic beauty of the decorative article 1. It is also acceptable to configure the topcoat layer 5 to be removed when, for example, the decorative article 1 is used.

Decorative Article

The decorative article 1 can be essentially any article having a decorative quality. Examples include interior and exterior decorative articles and decorative figures, jewelry, various external watch parts such as watch cases (e.g., watch bodies, back covers, and one-piece cases in which the body and back cover are a single integrated unit), watch bands (including buckles, clasps, and other mechanisms for opening and closing the band or bangle), watch dials, parts serving as watch hands, bezels (e.g., rotating bezels), winding crowns (e.g., screw-down locking crown), buttons, watch crystals, crystal rims, dial rings, gap covers and packing, internal watch parts such as movement base plates, gear wheels, train wheel bridges, and oscillating weights, eyeglasses (e.g., eyeglass frames), personal adornments such as necktie pins, cuff links, rings, necklaces, bracelets, anklets, broaches, pendants, and earrings (pierced and clamp-on), lighters and lighter cases, automobile wheels, golf clubs and other sports articles, name plates, panels, trophies, housings and other parts of various devices, and various types of containers. Among these articles, external parts for timepieces are particularly preferred. The external parts of timepieces are generally vulnerable to physical impact from the outside and need to be durable in order to be practical. At the same time, they need to possess a beautiful appearance. The present invention can simultaneously satisfy these requirements. In this patent specification, such expressions as “external part for a timepiece” refer to any part of a timepiece that is visible from the outside and is not limited to parts that are physically exposed to the outside. Thus, an “external part for a timepiece” can include parts that are enclosed inside a timepiece.

For reasons that will now be explained, it is particularly preferred that the decorative article 1 be a part (external part) for a radio controlled timepiece. In short, in addition to having an excellent aesthetic appearance and excellent durability, the decorative article 1 has excellent radio wave permeability because the substrate 2 is made of a plastic material. Therefore, the decorative article 1 can be used in a favorable manner as a part for a radio controlled timepiece.

A method of manufacturing the decorative article 1 described heretofore will now be described.

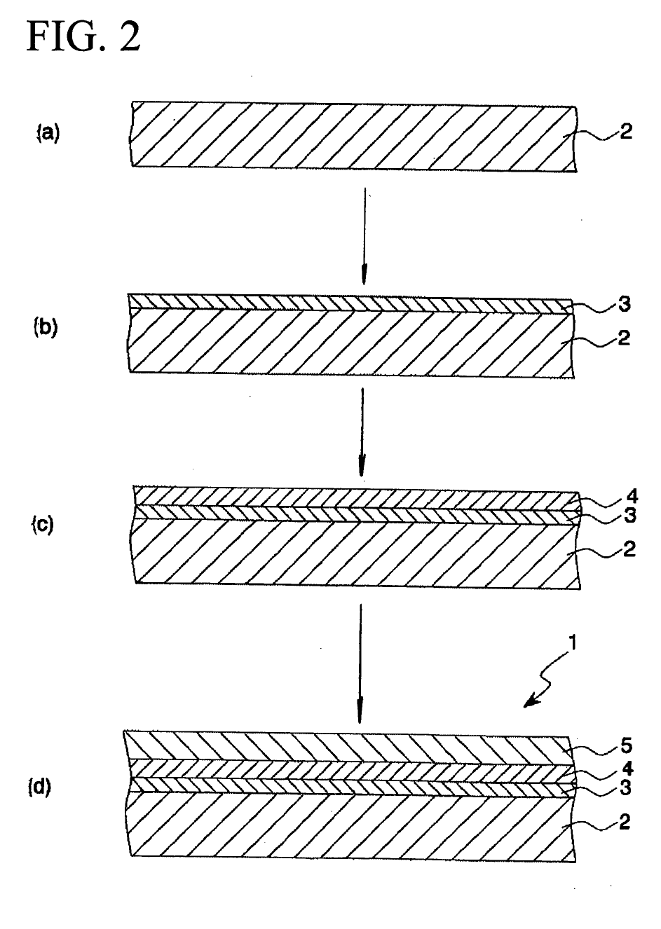

FIG. 2 is a series of cross sectional views illustrating a manufacturing method for a decorative article in accordance with the preferred embodiment of the present invention.

As shown in FIG. 2, the decorative article manufacturing method of this embodiment has the following steps: a first step (line b) in which a first film 3 is formed on at least a portion (line a) of the surface of a substrate 2; a second step (line c) in which a second film 4 is formed on at least a portion of the surface of the first film 3; and a topcoat layer forming step (line d) in which a topcoat layer 5 is formed on the surface of the second film 4.

Substrate

A substrate having the features described previously is used as the substrate 2.

Additionally, it is also acceptable to machine the surface of the substrate 2 to impart a mirror finish, a lined (streaked) finish, a dull (satin) finish, or the like thereto. By utilizing such surface finishes, variation can be imparted to the glossiness of the surface of the final decorative article 1 obtained, thereby improving the decorative quality of the final decorative article 1.

In comparison with a decorative article that is manufactured by applying surface machining to the first film 3 and the second film 4, a decorative article 1 manufacturing using a substrate 2 whose surface has been machined as just described achieves less variation in the second film 4 and has an excellent aesthetic appearance. Since the substrate 2 is made chiefly of a plastic material, it is comparatively easy to machine the surface to obtain the finishes mentioned above. Also, since the first film 3 and the second film 4 are comparatively thin, it is possible for the entire film (the first film 3 or the second film 4) to be removed at locations where surface machining is applied to the first film 3 or second film 4. By machining the substrate 2 instead, this problem can be prevented in an effective fashion.

First Step

In the first step, as shown in line b of FIG. 2, a first film 3 made of a material containing at least one metal selected from the group made of Ag and Al is formed on the substrate 2.

As described previously, the first film 3 has excellent adhesion with respect to both the substrate 2 and the second film 4. A distinctive characteristic of the present invention is that the durability of the decorative article 1 as a whole is improved by forming this kind of first film closer to the substrate 2 than the second film 4.

While there are no particular limitations on the method of forming the first film 3, examples include the following methods: coating methods such as spin coating, dipping, brush painting, spray painting, electrostatic coating, and electrodeposition; wet plating methods such as electrolytic plating, dip plating, and electroless plating; chemical vapor deposition (CVD) methods such as thermal CVD, plasma CVD, and laser CVD; dry plating methods (vapor deposition methods) such as vacuum evaporation, sputtering, and ion plating; and thermal spraying. Among these, dry plating methods (vapor phase film forming methods) are preferred. By using a dry plating method (vapor phase film forming method) to form the first film 3, a homogeneous first film 3 having uniform thickness and excellent adhesion to the substrate 2 can be formed in a reliable manner. As a result, the decorative article 1 ultimately obtained will have an excellent aesthetic appearance and excellent durability. Furthermore, by using a dry plating method (vapor phase film forming method) to form the first film 3, the variation of the film thickness can be held sufficiently small even when the first film 3 to be formed is comparatively thin. Consequently, the durability of the decorative article 1 can be held to a sufficiently high level while improving the radio wave permeability of the decorative article 1. Therefore, the decorative article 1 obtained can be used in a favorable manner as a part for a radio controlled timepiece.

Among the aforementioned dry plating methods (vapor phase film forming methods), sputtering is particularly preferred. When sputtering is used to form the first film 3, the effects described above become more prominent. More specifically, by using sputtering to form the first film 3, a homogeneous first film 3 having uniform thickness and excellent adhesion to the substrate 2 can be formed in a reliable manner. As a result, the decorative article 1 ultimately obtained will have an excellent aesthetic appearance and excellent durability. Furthermore, by using sputtering to form the first film 3, the variation of the film thickness can be held sufficiently small even when the first film 3 to be formed is comparatively thin. Consequently, the durability of the ornament 1 can be held to a sufficiently high level while improving the radio wave permeability of the decorative article 1. Therefore, the decorative article 1 obtained can be used in a favorable manner as a part for a radio controlled timepiece.

When a dry plating method is used as previously described, the first film 3 can be formed in a simple and reliable manner by using the metal that will form the first film 3 or metal corresponding to the metal compound that will form the first film 3 as a target and executing the film formation in an atmosphere containing a gas corresponding to the constituent material or materials of the first film 3. For example, if the first film 3 is to be made of a metal (including alloys), favorable results can be obtained by using argon gas or other inert gas as the gas forming the processing atmosphere. When the first film 3 is to be made of a metal oxide, favorable results can be obtained using a gas containing oxygen as the gas forming the processing atmosphere. Likewise, favorable results can be obtained using a gas containing nitrogen as the gas forming the processing atmosphere when the first film 3 is to be made of a metal nitride and favorable results can be obtained using a gas containing acetylene or other hydrocarbon as the gas forming the processing atmosphere when the first film 3 is to be made of a metal carbide.

It is also acceptable for the first film 3 to be formed using a combination of different methods and conditions. This approach can be used with favorable results to form a laminate first film 3 like that described previously.

Second Step

In the second step, as shown in line c of FIG. 2, a second film 4 made of a material (including alloys) containing at least one metal selected from the group made of Ag and Al is formed on the first film 3. While there are no particular limitations on the method of forming the second film 4, examples include the following methods: coating methods such as spin coating, dipping, brush painting, spray painting, electrostatic coating, and electrodeposition; wet plating methods such as electrolytic plating, dip plating, and electroless plating; chemical vapor deposition (CVD) methods such as thermal CVD, plasma CVD, and laser CVD; dry plating methods (vapor deposition methods) such as vacuum evaporation, sputtering, and ion plating; and thermal spraying. Among these, dry plating methods (vapor phase film forming methods) are preferred. By using a dry plating method (vapor phase film forming method) to form the second film 4, a homogeneous second film 4 having uniform thickness and excellent adhesion to the first film 3 can be formed in a reliable manner. As a result, the decorative article 1 ultimately obtained has an excellent aesthetic appearance and excellent durability. Furthermore, by using a dry plating method (vapor phase film forming method) to form the second film 4, the variation of the film thickness can be held sufficiently small even when the second film 4 to be formed is comparatively thin. Consequently, the durability of the decorative article 1 can be held to a sufficiently high level while improving the radio wave permeability of the decorative article 1. Therefore, the decorative article 1 obtained can be used in a favorable manner as a part for a radio controlled timepiece.

Among the aforementioned dry plating methods (vapor phase film forming methods), sputtering is particularly preferred. When sputtering is used to form the second film 4, the effects described above become more prominent. By using sputtering to form the second film 4, a homogeneous second film 4 having uniform thickness and excellent adhesion to the first film 3 can be formed in a reliable manner. As a result, the decorative article 1 ultimately obtained will have an excellent aesthetic appearance and excellent durability. Furthermore, by using sputtering to form the second film 4, the variation of the film thickness can be held sufficiently small even when the second film 4 to be formed is comparatively thin. Consequently, the durability of the decorative article 1 can be held to a sufficiently high level while improving the radio wave permeability of the decorative article 1. Therefore, the decorative article 1 obtained can be used in a favorable manner as a part for a radio controlled timepiece.

When a dry plating method is used as previously described, the second film 4 can be formed in a simple and reliable manner by using the metal that will form the second film 4 as a target and executing the film formation in an atmosphere containing argon gas or another inert gas. If the previously described first step is conducted using a dry plating method, e.g., if a vapor phase film forming machine is used with a chamber atmosphere composed of a gas containing oxygen gas, then the second step can be conducted using the same machine (without removing the substrate 2 from the machine) by changing over to an inert gas and, if necessary, changing the target. As a result, the decorative article 1 can be manufactured with improved productivity in addition to achieving excellent adhesion between the substrate 2, the first film 3, and the second film 4.

It is also acceptable for the second film 4 to be formed using a combination of different methods and conditions. This approach can be used with favorable results to form a laminate second film 4 like that described previously.

Topcoat Layer Forming Step

In the topcoat layer forming step, as shown in line d of FIG. 2, a topcoat layer 5 is formed on the second film 4. Formation of the topcoat layer 5 completes the decorative article 1.

While there are no particular limitations on the method of forming the topcoat layer 5, examples include the following methods: coating methods such as spin coating, dipping, brush painting, spray painting, electrostatic coating, and electrodeposition; wet plating methods such as electrolytic plating, dip plating, and electroless plating; chemical vapor deposition (CVD) methods such as thermal CVD, plasma CVD, and laser CVD; dry plating methods (vapor deposition methods) such as vacuum evaporation, sputtering, and ion plating; and thermal spraying. Among these, coating methods are preferred when the topcoat layer 5 is made chiefly of a resin material as described previously. By using a coating method, the topcoat layer 5 can be formed comparatively easily. When a coating method is used to form the topcoat layer 5, it is easy to add such components as coloring agents to the material used to form the topcoat layer and to adjust the quantity of those added components.

A timepiece provided with a decorative article in accordance with the present invention will now be described.

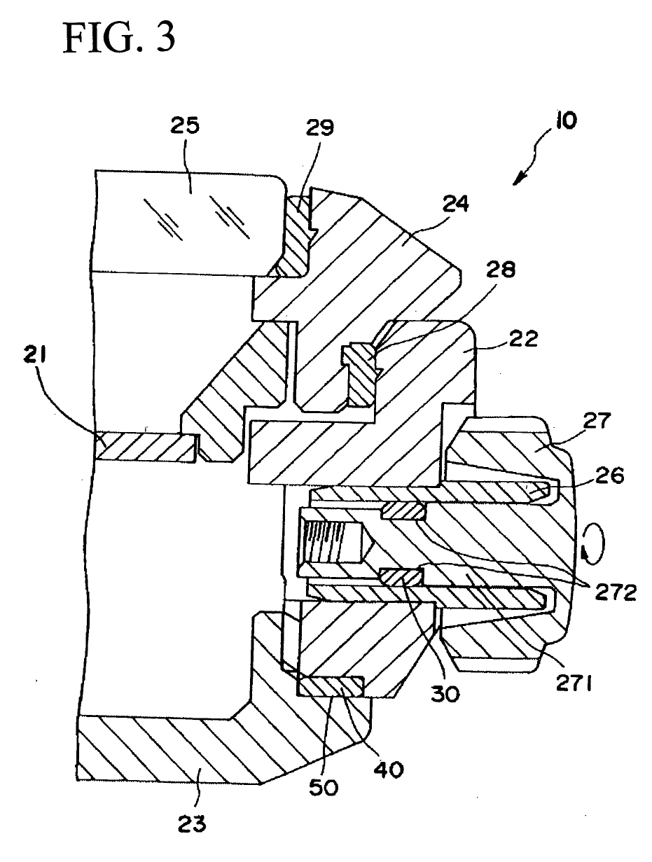

FIG. 3 is a cross sectional view showing a timepiece (wristwatch) 10 in accordance with a preferred embodiment of the present invention. As shown in FIG. 3, the wristwatch (portable timepiece) 10 of this embodiment has a body (case) 22, a back cover 23, a bezel (rim) 24, and a glass plate (crystal) 25. A dial 21 that employs a decorative article in accordance with the present invention is housed inside the case 22. Watch hands (not shown) are also housed inside the case 22 in the space between the glass plate 25 and the dial 21, and a movement (not shown) is housed inside the case 22 in the space between the dial 21 and the back cover 23. A winding stem pipe 26 is press fitted and thereby fixed into the body 22, and the winding stem (shaft part) 271 of a winding crown 27 is arranged in a rotatable manner inside the winding stem pipe 26. The bezel 24 and body 22 are fastened together by means of plastic packing 28, and the bezel 24 and glass plate 25 are fastened together by means of plastic packing 29. The back cover 23 is press fitted (or screwed) to the body 22 and the joint 50 between the two is sealed by a ring-shaped rubber packing (back cover packing) 40 that is installed to be in a compressed state. This arrangement seals the joint 50 in a watertight manner, and provides a waterproofing effect.

A groove 272 is formed in the outside circumference of the winding stem 271 of the winding crown 27 and a ring-shaped rubber packing (crown packing) 30 is fitted into this groove 272. The rubber packing 30 fits snuggly against the internal surface of the winding stem pipe 26 and is compressed between the internal surface of the winding stem pipe 26 and the inside surface of the groove 27. This arrangement seals the gap between the crown 27 and the winding stem pipe 26 in a watertight manner and provides a waterproofing effect. When the crown 27 is wound, the rubber packing 30 turns together with the winding stem 271 and slides in a circumferential path along the internal surface of the winding stem pipe 26 while maintaining a snug fit against the internal surface.

Although it has been explained that the dial employs a decorative article in accordance with the present invention, it is also acceptable if parts (decorative articles) other than the dial employ decorative articles in accordance with the present invention.

Here ends the explanation of the preferred embodiments of the present invention, but it should be noted that the invention is not limited to these embodiments.

For example, in the manufacturing method for a decorative article in accordance with the present invention, steps accomplishing any desired purpose can be added as required. For example, intermediate washing steps can be provided between the first step and the second step and between the second step and the topcoat layer forming step. It is also acceptable to perform such after treatments as grinding (lapping) after the topcoat layer is formed. It is also acceptable for to apply a pre-treatment to the substrate before executing the first step.

Although the previously described embodiments present a case in which the decorative article is provided with a topcoat layer, it is also acceptable if the decorative article is not provided with a topcoat layer.

Although the previously described embodiments present a case in which the first film is adjacent to the substrate and the second film is adjacent to the first film, it is also acceptable to provide one or more intermediate layers there-between. For example, a layer made of a metal material that substantially does not contain any Ag or Al can be provided between the first film and the second film.

Similarly, a layer made of a metal material that substantially does not contain any Ag or Al can be provided on the surface of the second film.

### WORKING EXAMPLES

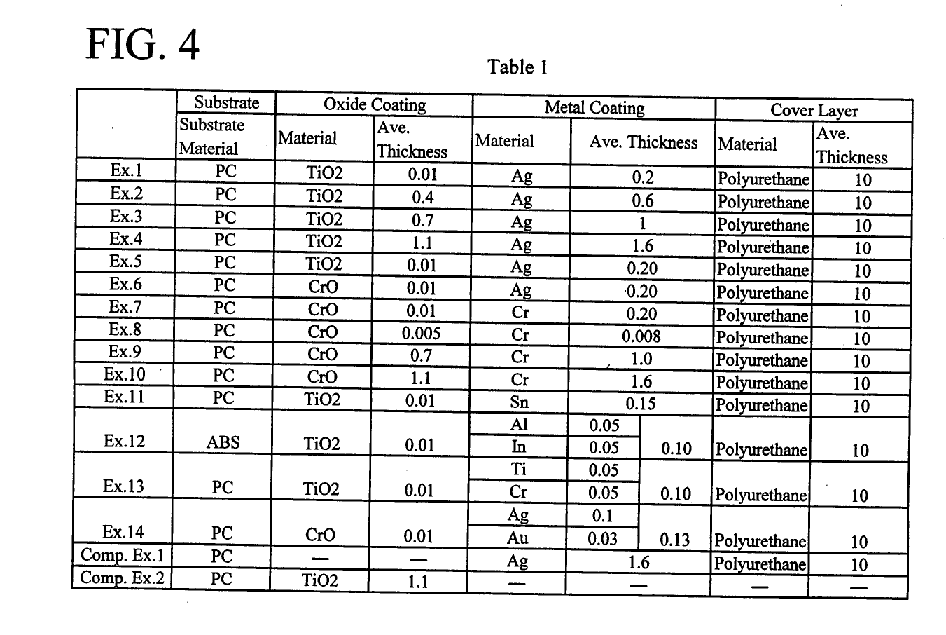

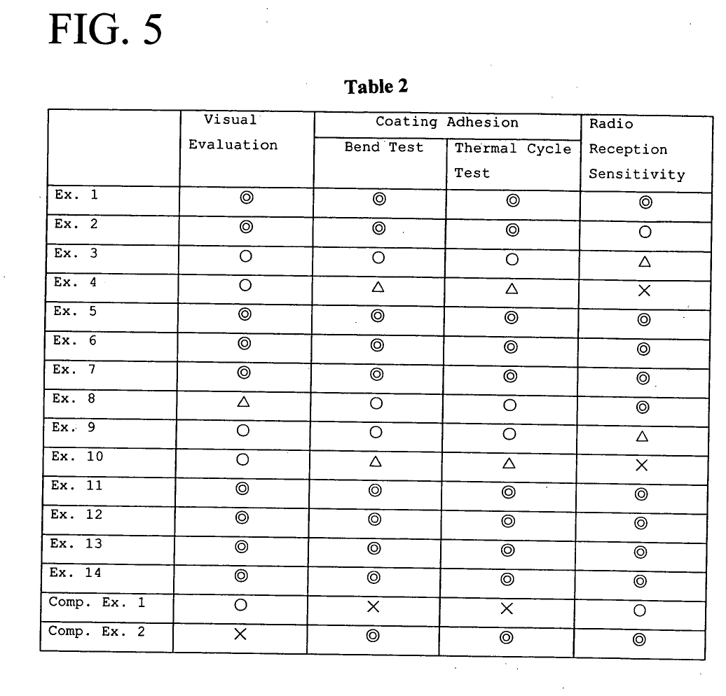

Concrete working examples of the present invention will now be described referring to FIGS. 4 and 5.

1. Structure of the Decorative Article

### Working Example 1

A decorative article 1 (external part (dial) of a wristwatch) was manufactured using the method described below.

First, polycarbonate was compression molded to fabricate a substrate 2 having the shape of an external part (dial) for a wristwatch. Then, the necessary portions of the substrate 2 were lathe cut and lapped. The resulting substrate 2 had the general shape of a circular disk and had a diameter of approximately 27 millimeters and a thickness of approximately 0.5 micrometer.

After fabrication, the substrate 2 was washed. The washing of the substrate 2 was conducted as follows. First alkaline electrolytic degreasing was performed for 30 seconds, followed by 30 seconds of alkaline dip degreasing. Then, neutralization was performed for 10 seconds followed by water rinsing for 10 seconds and deionized water rinsing for 10 seconds.

Next, a first film 3 made of TiO₂ was formed on the surface of the washed substrate 2 using the sputtering method described below (first step).

The washed substrate 2 was mounted in the sputtering machine and the inside of the machine was “preheated” while pulling (pressure reducing) the inside of the machine to a vacuum of 3×10⁻³ Pa.

Then, argon gas was introduced at a flow rate of 40 ml/minute and oxygen was introduced at a flow rate of 50 ml/minute. Using a Ti target under these conditions, electric discharge was conducted with an applied electric power of 1500 W and a processing time of 3 minutes to form a first film 3 made of TiO₂.

The resulting first film 3 had an average thickness of 0.15 micrometer.

Next, a second film 4 made of Ag was formed on the surface of the first film 3 using the sputtering method described below (second step).

First, the inside of the sputtering machine was pulled (pressure reduced) to a vacuum of 3×10⁻³ Pa and argon gas was introduced at a flow rate of 35 ml/minute. Using an Ag target under these conditions, electric discharge was conducted with an applied electric power of 1500 W and a processing time of 2 minutes to form a second film 4 made of Ag. The resulting second film 4 had an average thickness of 0.25 micrometer.

Next, the substrate 2, thus coated with the first film 3 and the second film 4, was washed again. The washing was made of first 30 seconds of alkaline dip degreasing followed by 10 seconds of neutralization, 10 seconds of water rinsing, and 10 seconds of deionized water rinsing.

Afterwards, a topcoat layer 5 of polyurethane was formed on the second film 4 (topcoat layer forming step). The topcoat layer 5 was formed using a spin coating method. The resulting topcoat layer 5 had an average thickness of 10 micrometers.

The thicknesses of the first film 3, second film 4, and topcoat layer 5 were measured according to the microscopical cross section examination method stipulated in JIS H 5821.

### Working Examples 2 to 4

Decorative articles 1 (external parts (dials) for a wristwatch) were manufactured in the same manner as Working Example 1 except that the processing times of the first step and second step were modified to obtain first and second films 3 and 4 having the average thicknesses indicated in Table 1.

### Working Example 5

A decorative article 1 (external part (dial) for a wristwatch) was manufactured in the same manner as Working Example 1 except that the substrate 2 was made using acrylonitrile-butadiene-styrene copolymer (ABS resin).

### Working Example 6

A decorative article 1 (external part (dial) for a wristwatch) was manufactured in the same manner as Working Example 1 except that the first film 3 was formed (first step) using a target made of Cr and conducting electric discharge with an argon flow rate of 40 ml/minute, an oxygen flow rate of 10 ml/minute, an applied electric power of 500 W, and a processing time of 4 minutes. The resulting first film 3 was made of CrO and had an average thickness of 0.15 micrometer.

### Working Example 7

A decorative article 1 (external part (dial) for a wristwatch) was manufactured in the same manner as Working Example 6 except that the second film 4 was formed (second step) using a target made of Cr and conducting electric discharge with an argon gas flow rate of 35 ml/minute, an applied electric power of 1600 W, a processing time of 1.5 minutes. The resulting second film 4 was made of Cr and had an average thickness of 0.25 micrometer.

### Working Examples 8 to 10

Decorative articles 1 (external parts (dials) for a wristwatch) were manufactured in the same manner as Working Example 7 except that the processing times of the first step and second step were modified to obtain first and second films 3 and 4 having the average thicknesses indicated in Table 1 of FIG. 4.

### Working Example 11

A decorative article 1 (external part (dial) for a wristwatch) was manufactured in the same manner as Working Example 6 except that the first film 3 was formed (first step) by conducting electric discharge in an argon gas atmosphere (argon gas flow rate of 35 ml/minute) with an applied electric power of 600 W and a processing time of 3.5 minutes. The resulting first film 3 was made of Cr and had an average thickness of 0.18 micrometer.

### Working Example 12

A decorative article 1 (external part (dial) for a wristwatch) was manufactured in the same manner as Working Example 6 except that the first film 3 was formed as a laminate having a Cr layer (first layer) made of Cr and a CrO₂ layer (second layer) made of CrO₂. The Cr layer and the CrO₂ layer were both formed using sputtering. The Cr layer was formed using a target made of Cr and conducting electric discharge in an argon gas atmosphere (argon gas flow rate: 35 ml/minute) with an applied electric power of 1500 W and a processing time of 0.5 minute.

Following the formation of the Cr layer, the CrO₂ layer was formed using a target made of Cr and conducting electric discharge with an argon gas flow rate: 30 ml/minute, oxygen gas flow rate of 10 ml/minute, an applied electric power of 1000 W, and a processing time of 1.5 minute.

The resulting Cr layer and CrO₂ layer respectively had average thicknesses of 0.1 micrometer and 0.1 micrometer. The first film 3 was constructed such that the Cr layer contacted the substrate and the CrO₂ layer contacted the second film 4.

### Working Example 13

A decorative article 1 (external part (dial) for a wristwatch) was manufactured in the same manner as Working Example 12 except that the processing times used in the first step for forming the Cr layer and the CrO₂ layer were modified to obtain a first film 3 having the average thicknesses indicated in Table 1 of FIG. 4.

### Working Example 14

A decorative article 1 (external part (dial) for a wristwatch) was manufactured in the same manner as Working Example 1 except that the first film 3 was formed as a laminate having a Cr layer (first layer) made of Cr and a TiO₂ layer (second layer) made of TiO₂. The Cr layer and the TiO₂ layer were both formed using sputtering. The Cr layer was formed using a target made of Cr and conducting electric discharge in an argon gas atmosphere (argon gas flow rate: 35 ml/minute) with an applied electric power of 1500 W and a processing time of 0.5 minute.

Following the formation of the Cr layer, the TiO₂ layer was formed using a target made of Ti and conducting electric discharge with an argon gas flow rate: 30 ml/minute, oxygen gas flow rate of 10 ml/minute, an applied electric power of 1000 W, and a processing time of 5 minutes.

The resulting Cr layer and TiO₂ layer had average thicknesses of 0.1 micrometer and 0.1 micrometer, respectively. The first film 3 was constructed such that the Cr layer contacted the substrate and the TiO₂ layer contacted the second film 4.

### Comparative Example 1

A decorative article 1 (external part (dial) for a wristwatch) was manufactured in the same manner as Working Example 4 except that the second film 4 was formed directly on the surface of the washed substrate 2 without forming the first film 3.

### Comparative Example 2

A decorative article 1 (external part (dial) for a wristwatch) was manufactured in the same manner as Working Example 4 except that neither a second film 4 nor a topcoat layer 5 were formed after forming the first film 3. The constituent features of the decorative articles manufactured in the working examples and comparative examples are summarized in Table 1 of FIG. 4. In the table, PC stands for “polycarbonate” and ABS stands for acrylonitrile-butadiene-styrene copolymer (ABS resin).

2. Evaluation of the External Appearance of the Decorative Article

The decorative articles manufactured in Working Examples 1 to 14 and Comparative Examples 1 and 2 were observed both with the naked eye and with a microscope and the appearance of each was evaluated according to the four categories listed below, which are listed in order of preference.
⊚: Excellent appearance
◯: Good appearance
Δ: Somewhat poor appearance
x: Poor appearance
   3. Evaluation of Film Adhesion (First Film and Second Film)

The adhesion of the films (first film and second film) of the decorative articles manufactured in the Working Examples 1 to 14 and the Comparative Examples 1 and 2 was evaluated using the two tests described below.

3.1 Bending Test

Each decorative article was bent about an iron rod having a diameter of 4 millimeters to an angle of 30 degrees with respect to a center of the decorative article. Afterwards, the appearance of the decorative article was observed with the naked eye and evaluated according to the four categories listed below, which are listed in order of preference. The bending was conducted in both the compressive and tensile directions.
⊚: No lifting or peeling of film observed
◯: Virtually no lifting of film observed
Δ: Lifting of film clearly observed
x: Cracking and peeling of film clearly observed
   3-2. Thermal Cycle Test

Each decorative article was subjected to the following thermal cycle test.

First, the decorative article was placed sequentially in a 20° C. environment for 1.5 hours, a 60° C. environment for 2 hours, a 20° C. environment for 1.5 hours, and a −20° C. environment for 3 hours. Then, the ambient temperature was returned to 20° C. and the cycle (8 hours) was repeated for a total of three cycles (total of 24 hours).

Finally, the appearance of the decorative article was observed with the naked eye and evaluated according to the four categories listed below, which are listed in order of preference.
⊚: No lifting or peeling of film observed
◯: Very little lifting observed
Δ: Lifting of film clearly observed
x: Cracking and peeling of film clearly observed
   4. Radio Reception Evaluation

The effect of each of the decorative articles manufactured in Working Examples 1 to 14 and Comparative Examples 1 and 2 on the radio reception of a radio controlled watch was evaluated in the following manner.

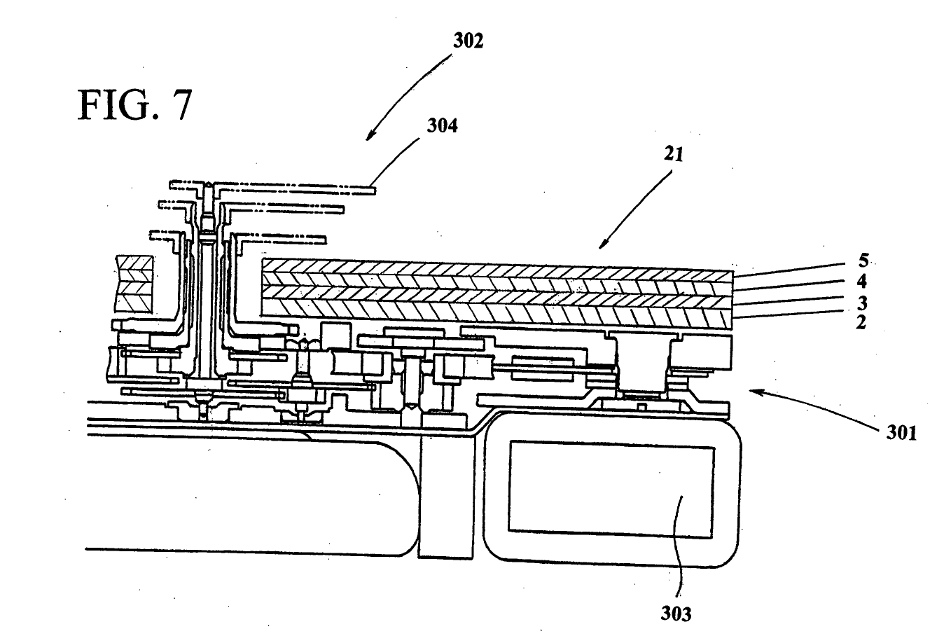

As shown in FIG. 7, a watch case and a wristwatch internal module (movement) equipped with an antenna 303 for receiving radio waves were prepared.

Referring again FIG. 4, the wristwatch internal module (movement) and the decorative article (dial) were installed into the watch case and the radio wave reception sensitivity was measured.

The amount (dB) by which the reception sensitivity decreases when the dial is installed in comparison with the reception sensitivity obtained when the dial is not installed was measured and evaluated according to the four categories listed below, which are listed in order of preference.
⊚: No reduction in sensitivity observed (below detectable limit)
◯: Sensitivity reduction of less than 1 dB observed
Δ: Sensitivity reduction of 1 dB or higher and less than 1.2 dB observed
x: Sensitivity reduction of 1.2 dB or higher observed

The results are shown in Table 2 of FIG. 5.

As is clear from Table 2 of FIG. 5, all of the decorative articles manufactured according to the present invention have excellent aesthetic appearances and the films (first film and second film) thereof have excellent adhesion. Furthermore, in the examples where thickness of the films (first film and second film) is in the preferred range of values, the aesthetic appearance is particularly excellent and the radio wave reception sensitivity is also excellent. Therefore, these decorative articles can be used in a favorable manner in a radio controlled timepiece. Conversely, satisfactory results were not obtained with the comparative examples. More specifically, the adhesion of the film (second film) was poor in the case of the decorative article of Comparative Example 1, in which a first film was not formed. Meanwhile, the external appearance of the decorative article was poor in the case of Comparative Example 2, in which a second film was not formed.

Additionally, a timepiece like that shown in FIG. 3 was assembled using the dial 21 (decorative article) obtained in each working example and comparative example. The thermal cycle test and radio reception evaluation described above were performed on each timepiece and similar results to those presented above were obtained.

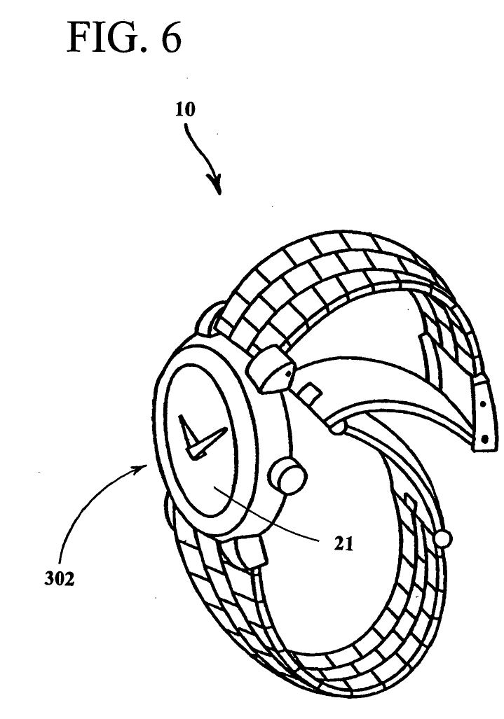

As seen in FIGS. 6 and 7, the timepiece 10 of the present embodiment preferably includes a drive unit 301 and a display unit 302 that has the dial 21 and a time indicator 304.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2004-026130. The entire disclosure of Japanese Patent Application No. 2004-026130 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A decorative article, comprising:
a substrate being made of a plastic material;
a first film being provided adjacent to said substrate, said first film containing at least one substance selected from the group consisting of Cr, Ti, compounds of Cr, and compounds of Ti; and
a second film being provided adjacent to a first surface of said first film, said first surface being on a side of said first film opposite a second surface of said first film, said second surface being arranged to face said substrate, said second film being made of a material containing at least one metal selected from the group consisting of Ag and Al.

2. The decorative article according to claim 1, wherein said substrate is made of a material containing at least one substance selected from the group consisting of polycarbonate and acrylonitrile-butadiene-styrene copolymer.

3. The decorative article according to claim 2, wherein said at least one substance is a metal oxide.

4. The decorative article according to claim 1, wherein said at least one substance is a metal oxide.

5. The decorative article according to claim 4, wherein said first film is a laminate having a plurality of layers.

6. The decorative article according to claim 1, wherein said first film is a laminate having a plurality of layers.

7. The decorative article according to claim 1, wherein
said first film has a first layer that includes Cr and a second layer that includes CrO,
said first layer is provided adjacent to said substrate, and
said second layer is provided adjacent to said first surface of said first layer.

8. The decorative article according to claim 1, wherein a thickness of said first film is from 0.01 to 1.0 micrometer.

9. The decorative article according to claim 1, wherein a thickness of said second film is from 0.01 to 1.5 micrometers.

10. The decorative article according to claim 1, wherein a sum of a thickness of said first film and a thickness of said second film is from 0.02 to 2.5 micrometers.

11. The decorative article according to claim 1, wherein a topcoat layer made of a resin material is provided over said second film.

12. The decorative article according to claim 1, wherein a topcoat layer is made of a urethane resin and/or an acrylic resin.

13. A timepiece comprising:
a drive unit; and
a time display unit being configured to display time having,
a dial having,
a substrate being made of a plastic material,
a first film being provided adjacent to said substrate, said first film containing at least one substance selected from the group consisting of Cr, Ti, compounds of Cr, and compounds of Ti, and
a second film being provided adjacent to a first surface of said first film, said first surface being on a side of said first film opposite a second surface of said first film, said second surface being arranged to face said substrate, said second film being made of a material containing at least one metal selected from the group consisting of Ag and Al, said decorative article being an external timepiece part, and
a time indicator being connected to said drive unit and located on said dial.

14. A radio controlled timepiece comprising:
a drive unit;
an antenna receiving radio waves; and
a display unit being configured to display time having
a dial having,
a substrate being made of a plastic material,
a first film being provided adjacent to said substrate, said first film containing at least one substance selected from the group consisting of Cr, Ti, compounds of Cr, and compounds of Ti, and
a second film being provided adjacent to a first surface of said first film, said first surface being on a side of said first film opposite a second surface of said first film, said second surface being arranged to face said substrate, said second film being made of a material containing at least one metal selected from the group consisting of Ag and Al, said decorative article being a part for a radio controlled timepiece, and
a time indicator being connected to said drive unit and located on said dial.

15. A method of manufacturing a decorative article comprising:
preparing a first film containing at least one substance selected from the group consisting of Cr, Ti, compounds of Cr, and compounds of Ti being formed on at least a portion of a surface of a substrate having a plastic material; and
preparing a second film containing at least one metal selected from the group consisting of Ag and Al is formed on at least a portion of a surface of said first film.

16. The decorative article manufacturing method according to claim 15, wherein preparing said first film is executed using a vapor phase film forming method.

17. The decorative article manufacturing method according to claim 16, wherein preparing said first film is executed using sputtering.

18. The decorative article manufacturing method according to claim 15, wherein preparing said second film is executed using a vapor phase film forming method.

19. The decorative article manufacturing method according to claim 18, wherein preparing said second film is executed using sputtering.

20. The decorative article manufacturing method according to claim 15, further comprising forming a topcoat layer including a resin material.
